(19) United States
(12) Patent Application Publication
(10) Pub. No.: US 2003/0093383 A1
(43) Pub. Date: May 15, 2003

(54) Method for providing franking

(76) Inventors: Karl Reich, Radolfzell (DE); Walter Rosenbaum, Paris (FR); Ingolf Rauh, Reichenau (DE); Graeme McLintock, Konstanz (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 09/974,776

(22) Filed: Oct. 11, 2001

(51) Int. Cl. G06F 17/60

(52) U.S. Cl. 705/60

(57) ABSTRACT

The present invention relates to a method for electronic franking wherein the customer is provided with an authenticable code which may be written or otherwise printed on a mail piece or mail piece. Given the authentic nature of the code, the code may be provided remotely. The code may be linked to a delivery address, the relationship later verified. Alternatively, the code may be the result of applying a precode and date of purchase to an algorithm thereby producing a resulting code. The resulting code can be easily verified. The algorithm is complex and difficult to reverse engineer, including an encryption algorithm.

### BACKGROUND OF THE INVENTION

The present invention relates to the field for franking and more particularly to method for providing and authenticating franking wherein no special computer software nor hardware is required in advance of or for repeat purchase.

Current franking procedures entail affixing a mail piece or parcel with special markings indicating that a certain amount of postage has been paid. The markings are a substitute for stamps and convenience both the customer and postal system in reducing the necessity of acquiring and affixing stamps to the mail piece or parcel. Franking machines may be stand alone machines having internal security and printing works. The security works are normally components that are purchased from a post office and manually inserted into the machine. The components may include a certain postage amount that runs down over usage. The printing works prints a marking on an envelope or other mail piece or parcel, indicating a certain postage amount.

In addition to such stand alone machines, with the advent of the Internet, another generation of machines are known which purchase postage remotely, via a dial up computer. The computer dials into an Internet site operated by a postage dispensing service. To ensure security with the on-line purchase, unique hardware and/or software is required. In addition, knowledge of computers and their operations is also required. Likewise, with both stand alone machines and computers, one is limited with respect to envelope size, use of window envelopes as well as automatic readability issues that arise due to paper and print quality. Markings may get damaged or incur print errors resulting in unreadable markings, delayed or returned mail piece or parcels, and loss to the customer. Likewise, special equipment and operational knowledge thereof is required.

Accordingly, a need exists for a method of franking mail piece or parcels requiring no special machines, computer software, hardware and the like; high availability taking advantage of modern communication means; easy to use in that no special instructions are required; secure in both purchase and implementation; add value to business associated therewith; be available to remote purchase by both single mail piece or parcel and large volume mailers; robust automatic readability properties and be otherwise unobtrusive to the mail piece or parcel such that normal postal processing can still occur. Furthermore, a need exists for the method to be free of third parties or other intermediaries which may complicate the franking process.

### SUMMARY OF THE INVENTION

It is an advantage of the present invention to provide an easy to use method of franking a mail piece or parcel that requires no special machines, computer software or hardware, expertise, third party intermediaries, large amounts of time, and the like. It is a further advantage that mail piece or parcels franked according to the present invention are easy to authenticate and process by the postal system. It is a further advantage that mail piece or parcels and mail pieces so franked enjoy ease of automatic reading based on well established, robust operating principles of Optical Character Recognition (OCR) and existing Video Coding for recovery of those franking that prove to not be OCR readable. A still further advantage is that the mail piece or parcels are not obtrusively marked such that normal mail piece or parcel processing is facilitated. These and other advantages will become apparent from the present invention which comprises a method whereby a customer contacts a postage providing service, provides select information and payment to the service, is provided with an alphanumeric code, which the customer then applies to the mail piece or parcel. The select information involved in the practice of said invention includes mail piece or parcel delivery address, a random alpha/numeric identifier string or an algorithmically constituted and formatted alpha/numeric identifier coupled with date of purchase. Both embodiments reflect the core inventive property of an ease of use, aesthetic franking with high if not absolute revenue protection that is read and validated by current generation OCR technology. The revenue protection aspects of said patent can be extended to further include mail piece or parcel size and/or weight. The customer can apply the code to the mail piece or parcel by any means known in the art ranging from a pen to a computer printer. The code is authenticated when the mail piece or parcel is received and processed by the postal system. The code authenticity may be linked to the delivery address or encryption algorithm.

The advantages are further realized by a method of providing mail piece or parcel franking, comprising the steps of: receiving a request for franking from a customer, said request including a delivery address and payment; generating a franking code; transmitting said franking code to said customer; affixing, by said customer, said franking code to said mail piece or parcel; receiving said mail piece or parcel with franking code affixed thereon; verifying authenticity of said franking code; and printing an identification code on said mail piece or parcel.

These and other advantages will become clear from the following detailed description and appended claims. The invention will be described in accordance with the following figures wherein like numerals refer to like parts.

### BRIEF DESCRIPTION OF THE SEVERAL VIEWS OF THE DRAWINGS

FIG. 1 depicts a flowchart of the present method;

FIG. 2 depicts a first Transaction Number (TAN);

FIG. 3 depicts a second TAN;

FIG. 4 depicts application of the second TAN;

FIG. 5 depicts a verification of the second TAN;

FIG. 6 depicts purchase of TAN by telephone; and

FIG. 7 depicts purchase of TAN by SMS.

### DETAILED DESCRIPTION OF THE INVENTION

The present method requires storage, retrieval, searching, comparing, sorting and other data manipulation which is facilitated by computer means programmed by one skilled in the art to accomplish the following method. A certain working knowledge of computers is implied by implementation of the present method. The computer means comprises a processor operating a memory, input, output, software and communication means as envisioned by one skilled in the art. In addition, the computer may be a stand alone or part of a network.

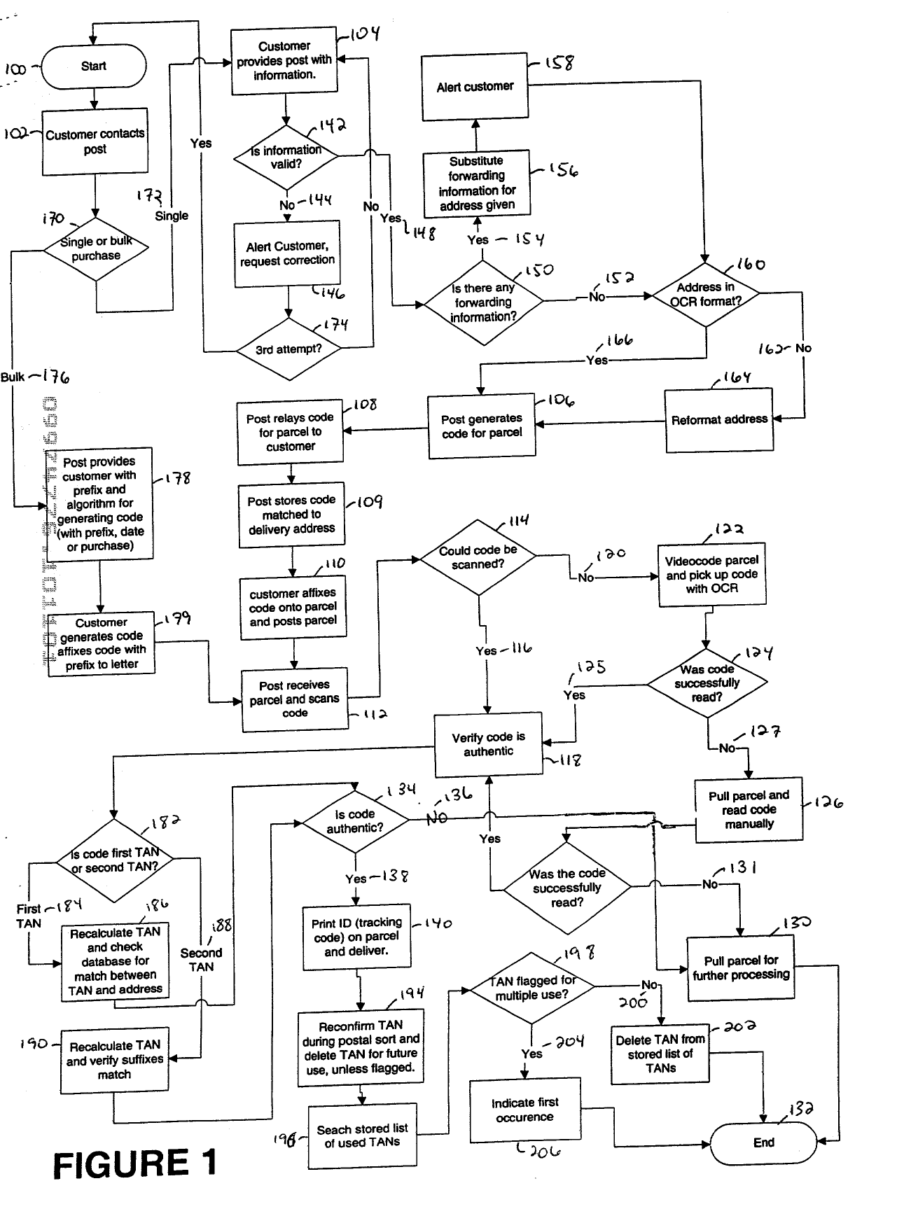

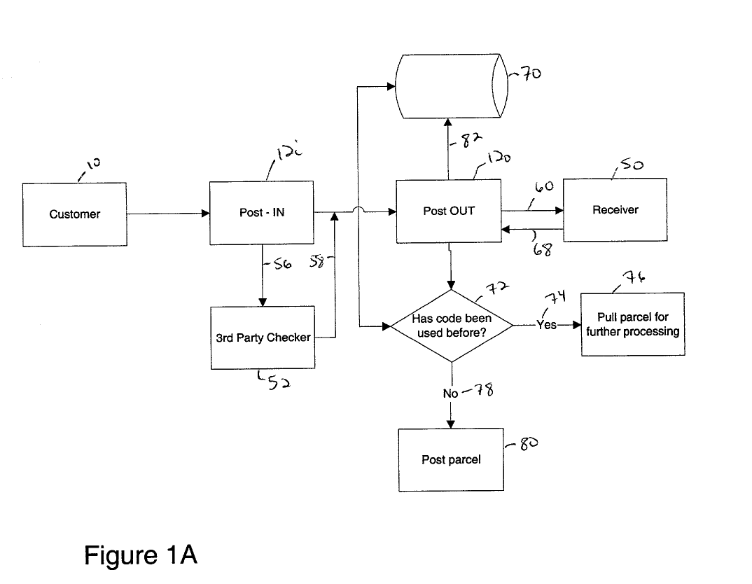

FIG. 1 depicts a flowchart of the present method. The method begins at step 100 and proceeds to the next step. The customer, wishing to purchase franking postage, contacts a postage vender, in this case the Post 102. The customer indicates whether the purchase is for a single or bulk mailings 170. Where the purchase is for a single mailing 172, the customer provides the Post with information 104. The information includes payment means, and delivery address (or zip code) or date of purchase. The date of purchase as recorded by the Post may also be used in the franking formulation. In addition, the customer may provide other related/identifying information such as mail piece or parcel size or weight so as to obtain accurate postage. A determination is made whether the information is valid. Payment is verified. Where a delivery address is provided, a determination is made whether the delivery address exists 142. If the delivery address does not exist 144, the customer is alerted 146 correction requested. The customer is provided with three attempts 174 after which the method returns to start 100. When the information is determined to be valid 148, a determination 150 is made whether there is any forwarding information or similar instruction associated with the delivery address. Similar instructions may be a cancellation of delivery due to a relocation. If there is no associated information 152, the method proceeds to step 160. If instructions are present 154, the information is substituted for the delivery address 156, the customer is alerted 158, and a determination 160 is made whether the address as recorded is formatted so as to facilitate optical character recognition (OCR). If the address is found to have extraneous information or be organized in a manner that can cause problems with OCR processing 162, the address is reformatted 164 either by the Post and transmitted as part of the franking data set back to the customer. The method then proceeds to step 106. If the address is in OCR format 166, the method proceeds to step 106 wherein a first franking code or first transaction number (TAN) is generated and provided to the customer (108). In addition, the Post provides the customer with a personal identification number (PIN) which may be used later for authentication. Said TAN is a short, 4 or 5 digit number which when coupled with the subject address (provided by the customer) is a unique data record. This data record is electronically stored by the Post along with other associated information such as weight, class of postage etc. which are indicative of a postage value sufficient to send the mail piece or parcel to the delivery address. Details of the code generation are discussed below as are the means of providing the code and general communication between the customer and Post. The TAN and delivery addresses, associated or matched together, is stored by the Post 109 for future authentication purposes. The customer affixes the code to the mail piece or parcel 110. The affixing may be in the form of printing with a machine operated printer, manually writing the code on the mail piece or parcel, affixing a properly printed label, and the like. The method then continues to step 112.

Returning to step 170, if the customer desires codes for bulk or large volume mailings 176, the customer is provided with a prefix and algorithm 178. In addition, the customer may be provided with a personal identification number (PIN) which is later used for authentication. The prefix comprises a two place alphanumeric code, possibly generated at random, and uniquely assigned. The algorithm may comprise any encryption algorithm which is extremely difficult to reverse engineer. Such algorithms are known to include a myriad of complex functions including modulo and use of combination of parts of a resulting number. An example algorithm is set out below, although the present invention is not limited to any one algorithm. The customer then generates a code using the algorithm and affixes the code with prefix on a mail piece or parcel or mail piece to be mailed 179. The date of code generation and amount of purchase are stored by the Post for later access 180. The method continues to step 112.

The customer deposits the mail piece or parcel or mail piece in the post which receives the mail piece or parcel or mail piece and scans the code thereon 112. A determination is made whether the code was properly scanned 114—the scan of the code, once decoded produces usable data. If the scan was properly scanned 116, the method proceeds to step 118. If the code was not properly scanned 120, the mail piece or parcel image is sent to a videocoding device including a display and data entry means suitable for an operator to view and manually enter the data related to the Electronic Postage data set and code 12X. A determination is made whether the videocode successfully recovered the code 124. If the manual intervention was successful 125, the method proceeds to step 118. If the manual intervention was unsuccessful 127, the mail piece or parcel is manually rejected from the system for further specialist examination 130 or returning the mail piece or parcel to its sender. The method then ends 132 (or optionally return to start 100, as may be done whenever end 132 is encountered). If the code was manually recovered by video coding 129, the method proceeds to step 118. If the code could not be manually read 131, the mail piece or parcel is set aside for further processing 130.

Returning to step 118, the code is authenticated. A determination is then made whether the TAN is based on a single mailing (first TAN) or bulk mailing (second TAN) 182. In the event it is a first TAN to be authenticated 184, an electronic memory is query to determine if the TAN and delivery address have matches therein 186 (per step 109). A match would indicate whether the TAN is authentic (134, 138). In the event of a second TAN 188, the TAN is recalculated using the date of purchase and algorithm associated with that date so as to generate a suffix code 190. The generated suffix code is compared to the suffix code printed on the mail piece or parcel. A match would indicate authenticity (134, 138). If the code is not authentic 136, the method proceeds to step 130, wherein the mail piece or parcel is set aside. If the code is authentic 138 a tracking code is printed on the mail piece or parcel 140 and the mail piece or parcel is routed accordingly. Application of identification codes are known in the art. An authentic code is one properly issued by the Post, was not used more than once, and is of sufficient value to facilitate delivery of the mail piece or parcel. A second off-line verification 194 of the TAN is performed as the mail piece or parcel is routed by the Post. The electronic memory where a list of TANs is stored is searched for the TAN and determination is made whether the TAN includes a flag indicating permissible multiple use 198 reflection the possible need in peak periods to randomly choose codes among the plurality of properly constituted and assigned codes for reuse. If no flag is present 200, the TAN is deleted 202 and the method ends 132. If the flag exists 204, an indication is made that a first TAN was found 206 and the method ends. In addition, a list of PINs associated with customers, codes, delivery addresses and the like is stored at the post or third party checker. The list is consulted when the PIN is used for authentication. The PIN is requested from the customer or other interested party. The presence of the PIN in the storage being an indication of authenticity. The PIN generation may be performed by a random generator. PIN generation, storage, consultation is performed by means known in the art.

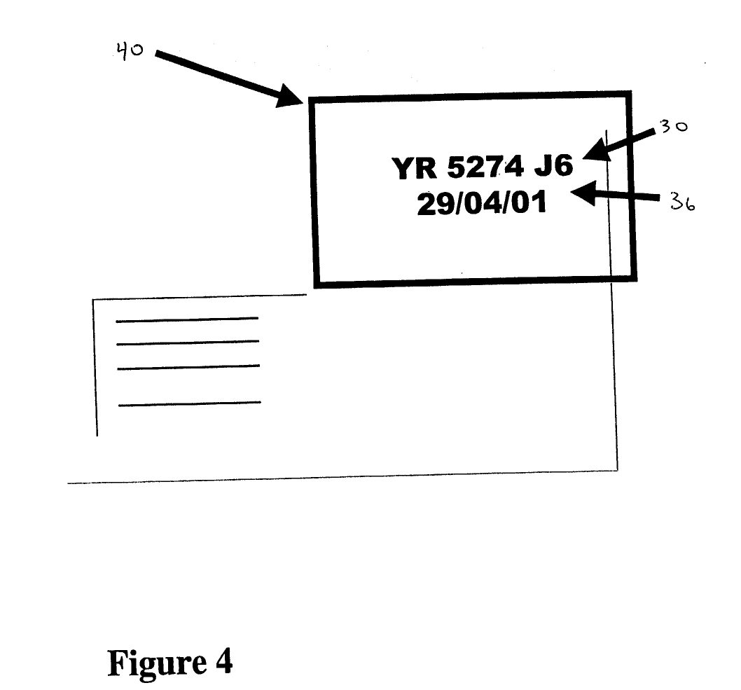

Alternative to the above method, a first TAN can be used for multiple uses and the second TAN could be used for a single purchase. The Prefix and 4/5 digit daily code are assigned by the Post to be printed along with the Suffix and date of purchase as a label. Based on date of purchase a given algorithm for encoding Prefix and 4 digit daily code as independent variables which generates the Suffix as a dependent variable. The resulting label (FIG. 4) can be applied to any mail piece or parcel independent of its address. In this instance the OCR upon reading the Prefix and numeric code and purchase date causes the related daily algorithm to be accessed and when provided with the OCR resolved Prefix and 4/5 digit code are encoded to provide the Suffix.

FIG. 1B depicts an embodiment of the present method including a third party checker or service provider 52 who acts as an intermediary between the Post and the postage purchaser. A third party checker/service provider comprises a party different from the Post 10, having the function and authorisation for dispensing and authenticating the first and/or second TAN code.

In operation, the customer reaches the Post by Internet or phone but the ope4ration is transferred and serviced by a non-postal agent who initially operates the process that generates and assigns the postage under previously disclosed first and second TAN operations. The purchaser of postage applies the corresponding first or second TAN code to the mail piece or parcel to be mailed. The parcel is then delivered to the Post 54 (FIG. 1B). The Post receives the parcel at an originating location 12i. The parcel is scanned and the information relayed 56 to a third party checker 52. The 3rd party checker performs the above discussed steps (186, 190) of verifying the first and/or second code. Authenticity information is then relayed (58) to the Postal originating/outbound or destination/inbound location depending on whether first or second TAN is in effect. Locations 12i/12o either withhold further sorting or withholds delivery depending upon code authenticity. Accordingly, it is the third party checker 52 who performs authentication rather than the Post. The Post destination/inbound location 12o is the local branch of the Post proximate to the receiver 50.and the postal originating/outbound location 12i is proximate to the sender.

Locations 12i and 12o further include electronic storage means storing 70 which maintains a record of all authenticated codes that have transited their respective location either being outward sorted to another destination post (e.g. 12o) or inward sorted for local delivery within their catchment. Fraudulent reuse of a Second TAN code, i.e. duplication, is by an large confined to either the sender 10 or receiver 50 (or parties with immediate access to them) since they are the only parties who have direct access to the Second TAN codes. This fraudulent reuse is thereby prevented since such duplicated Second TAN postage will reenter the mail processing network at either the origin or destination postal centers where databases for direct validating have been compiled as part of the Second TAN validation process when the postage was legally used.

Should the received attempt to copy the code onto another mail piece and mail it 68, the mail piece will be received by the local Post branch of location 12o. Location 12o checks 82 all incoming codes and determines 72 if there is a record of the code already in use—namely, is there a record of the code in storage means 70. If the code is present 74, the mail piece or parcel is pulled for further processing 76. Such processing may include criminal or civil prosecution. Should the code not be located 78 in storage means 70, normal processing as discussed above commences 80.

An additional source of verification comes from the codes themselves. Each code may include notation as to a particular date of use. For example with the first TAN, the first character (18) may be date specific. Likewise, the precode 32 of the second TAN may also be date specific. Verification or authentication routines operate as part of steps 186, 190 and 72 and may be performed by the Post 12 and/or third party checker 52. The means for executing the authentication are known in the art.

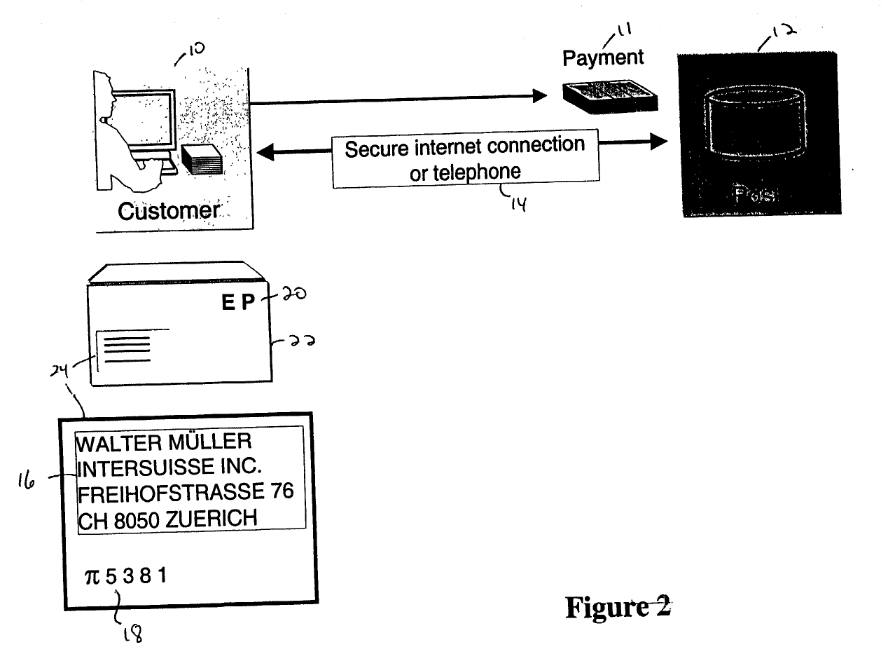

Still a further source of data conveyance in the First and Second TAN may comprise a special marking for with indication 20 (discussed below) indicating the type and/or class of mailing. For example, EP is depicted in FIG. 2. EP1 may be used to indicate first class and EP2 for second. EPAM may indicate air mail, EPP may indicate a parcel and EPB may indicate a box. Other combinations are possible as would be imagined by one skilled in the art.

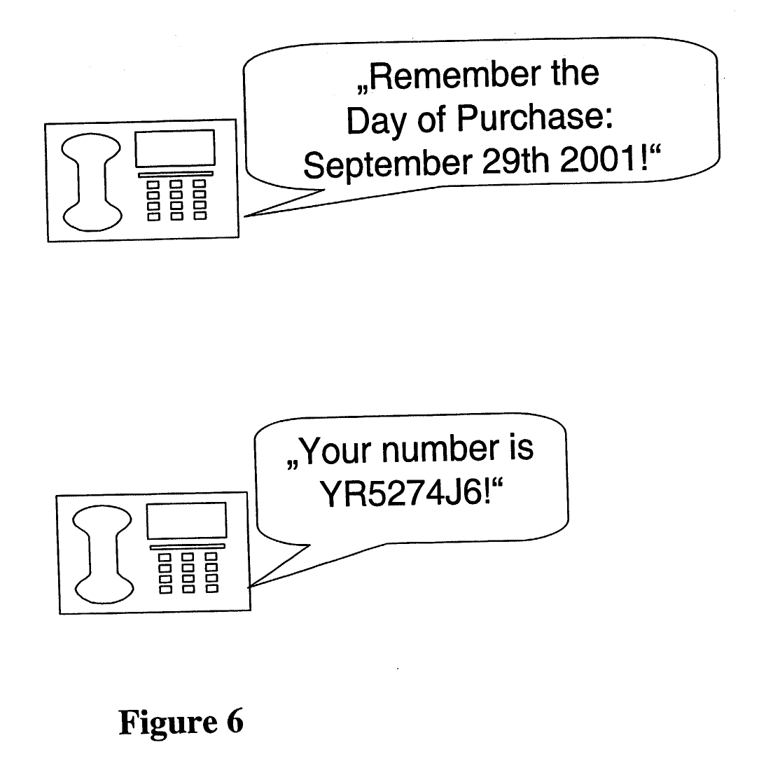

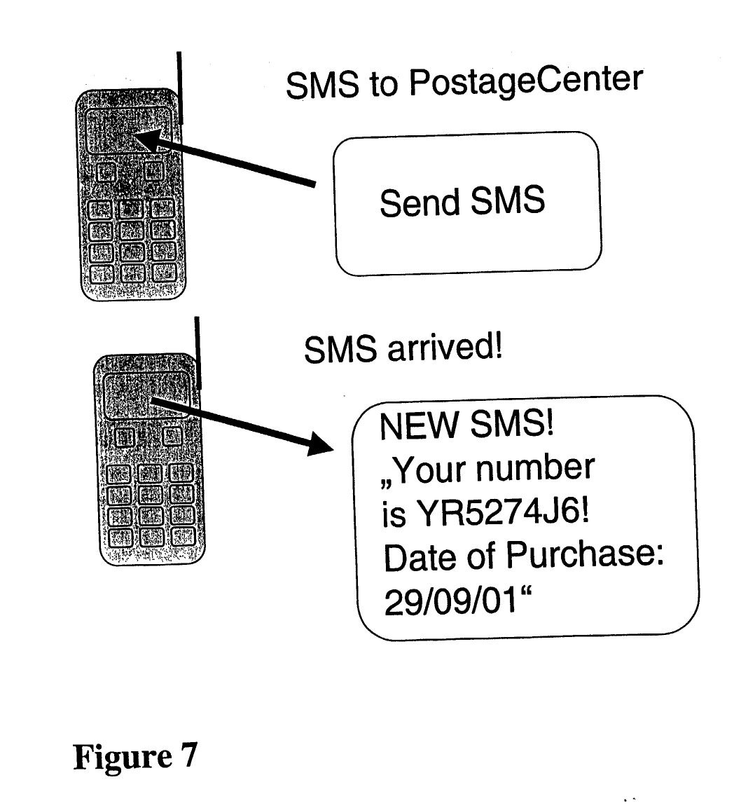

FIG. 2 depicts a method of purchasing the first transaction number or first TAN. Herein a secure internet or telephone connection 14 (see also FIG. 6) is established between a customer 10 and a postage selling operation or Post 12. Alternative communications include SMS (FIG. 7), fax (not shown), e-mail (not shown) and in person transaction. Other secure connections modes are possible. Customer 10 provides Post 12 with payment 11 and delivery address 16. The customer may also provide the post with mail piece or parcel information such as weight and/or dimensions so as to facilitate spot checking to confirm that sufficient post has or will be put on the mail piece or parcel. The delivery address 16 is depicted in OCR format. In accordance with step 160 above, the first TAN 18 is generated and communicated to the customer via the secure internet or telephone connection 14. As depicted, first TAN 18 comprises an alphanumeric symbol followed by four numerals assigned in sequence. The alphanumeric character may be updated depending upon volume of sales, day of the week, or other delineation. The four numerals may be generated sequentially or via an algorithm (complex or simple). The actual generation of the first TAN can be performed by a properly programmed computer as would be known to one skilled in the art. An alternative configuration is possible, provided it is easy to understand, read, print or write onto a mail piece or parcel and otherwise tracked.

The customer, now having the first TAN, inserts it into an address window 24 of mail piece or parcel 22 or can print it directly upon the mail piece or parcel or print the address and Tan on a sticker to be affixed on mail piece or parcel. In addition, the mail piece or parcel is marked in the upper right hand corner with an indication 20 that the mail piece or parcel was electronically franked—herein symbols E P. Said symbology or extensions thereof can also be used to as a machine readable indicator to facilitate orienting the mail piece or parcel for automatic scanning (called Facing) and determination of mail class. The post meanwhile, stores the association or match of first TAN with delivery address (per step 109 above). The mail piece or parcel 22 is posted. During processing, the Post scans the address and first TAN. As the address is in OCR format (16), few errors in reading are encountered thereby speeding up the overall process. The first TAN is authenticated by comparing the read first TAN and delivery address with the stored first TAN address combination (step 118, FIG. 1). The combination is authenticated to prevent the fraudulent step of applying a TAN to a different mail piece or parcel or different delivery address, than originally disclosed to the Post, the differences for example requiring additional postage. The retrieval of the stored combination and comparison with the read data is known to one skilled in the art. First TAN authentication may be performed a second time during post sorting prior to deletion of the first TAN from the its stored location. The deletion of the first TAN is to prevent unauthorized multiple use of the first TAN.

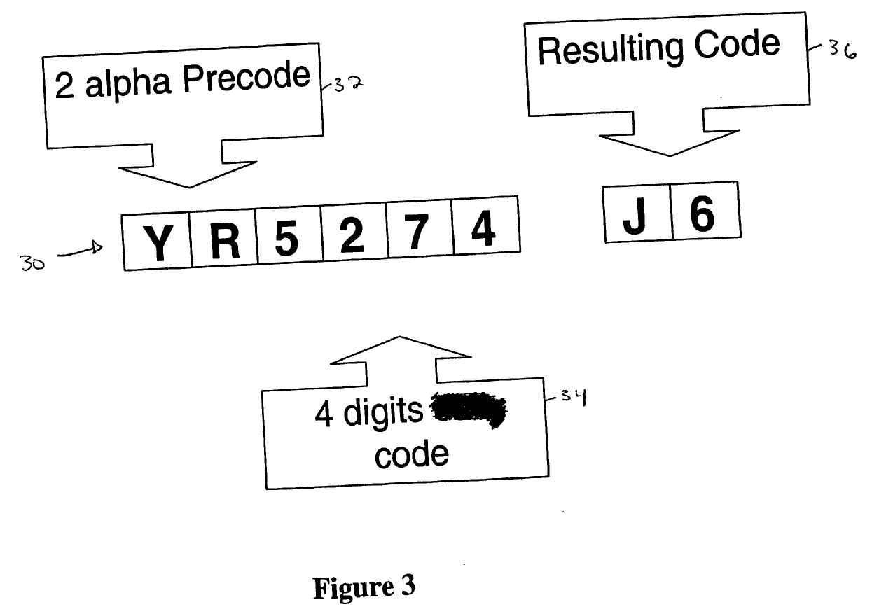

FIG. 3 depicts a second Tan 30. The second Tan comprises a two digit precode 32, followed by four digit numeric code 34 and two digit resulting code 36. The two digit precode can be assigned to large volume mailers or associated with a select time period (select day, week, etc.). The precode comprises alphanumeric characters. The numeric code is depicted as the same as the above first TAN for example purposes. As with the above, the numeric code may be generated sequentially or via application of an algorithm (complex or simple). A complex and/or encryption algorithm is applied to the date code and precode. The result of the application produces the resulting code 36. The second TAN 30 comprises the precode, daily code and resulting code. The second TAN 30 and date of purchase 38 are applied to a mail piece or parcel as depicted in FIG. 4. The application is in the top right hand corner 40 where postage is normally placed. Authentication of the second TAN 30 then becomes a matter of comparing the resulting code to the one Post derived from the precode and date of purchase—information obtained from the mail piece or parcel. Where the resulting code does not match, the mail piece or parcel is not authorized.

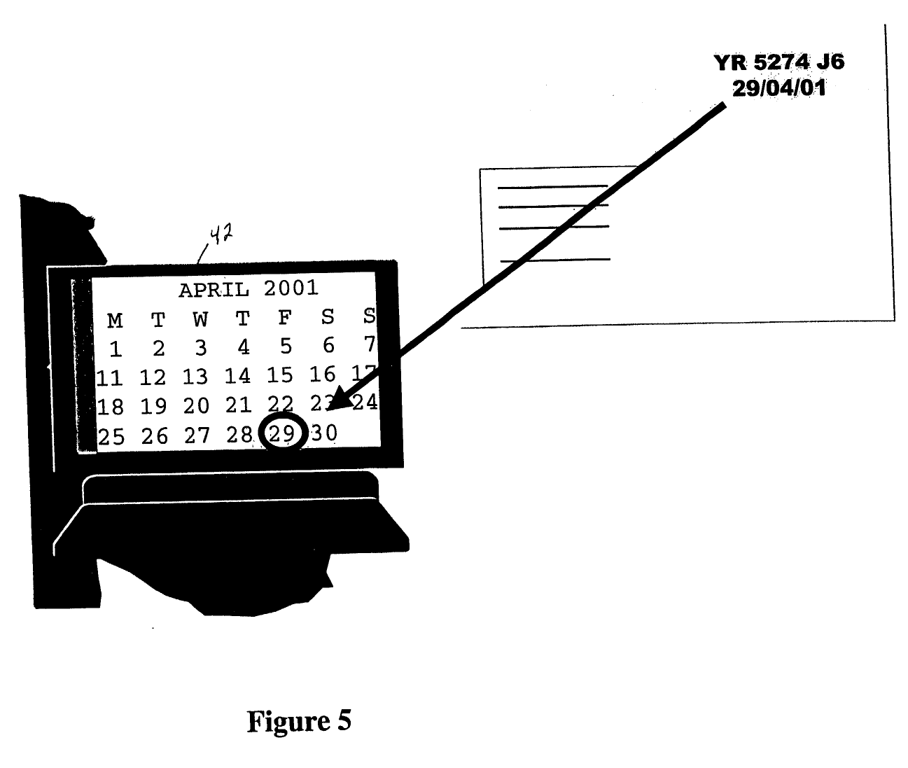

In normal practice, when a second TAN fails to validate (i.e. the Suffix does not match that generated by the daily algorithm using the OCR resolved Prefix and numeric code) or if the second TAN was not OCR readable, before rejection as invalid, fraudulent postage the practice of this invention will make use of video coding. The video coding authorization can be performed by a properly programmed computer (42, FIG. 5) having a graphical user interface depicting for example a calendar wherein the algorithm is preprogrammed. The user simply clicks on the date shown on second TAN and then enters the Prefix and numeric code. The Suffix is then automatically generated. If it matches the displayed Suffix code then the mail piece is accepted. Alternatively all the second TAN information is entered, including Suffix and the system makes the final authorization. An example encryption algorithm and its application are discussed below.

The following is an example algorithm only. Other algorithms may be used. The algorithm is changed on a daily basis. In addition, it is preferable that the algorithm is not easily reverse engineered so as to ensure security. First the purchase date is transformed in an integer (typically the days after Jan. 1, 1970): 28.08.2001→37131. 37131 is arrived at by counting the number of days starting with Jan. 1, 1970. Alternative numbers and method for arriving there may be used as imagined by one skilled in the art, such as limiting the counting and code validity to a single year. The prefix and the code are separated: A0 Prefix; 2458 Code. Both prefix and code are arrived at sequentially in order of unused prefixes and codes. The prefix may begin at AA and run to AZ. After which, numerals may be introduced. The four digit code may be generated at random (and tracked so as to prevent duplicate usage) or sequentially. Each digit/letter of the prefix is transformed in a numeric (for example the ASCII Value representation): A and 0→65 and 48. To complicate the encryption, for each date of purchase two factors are used (factor1 and factor2) as retrieved from a look up table. The factors may be selected at random on purposely. Specification factor1 for 28.8.2001: 4716211. Specification factor2 for 28.8.2001: 521688. A complicated, not easy to decrypt algorithm is used to calculate a resulting number. For example: ((Ln (date)*(Sum of ASCII representations)*In (code)*Factor1(Date)*Factor2(Date)) modulo 1000000)+9999. When applied, one arrives at (Ln (37131)*(65+48)*In (2458) 4716211*521688) modulo 1000000+9999=602371. From this result (602371) we take the third and second digit as Value 1=02 and the second last and last digit as Value 2=23. A modulo operation will generate a number, for example (Value 1+Value 2) modulo 62. This translates into (02+23) modulo 62 =25. From the same result (602371) we take the forth and fifth digit as Value 3=37, and the fifth and sixth digit as Value 4=71. Again a modulo operation is done and will generate a number, for example: (Value 3+Value 4) modulo 62. From here, one arrives at (37+71) modulo 62=46. Both resulting numbers (25, 62) are now transformed (via a transforming table or via the ASCII representation) to alphanumeric or numeric digits. The result as suffix is: PK. The algorithm can also be changed by using a table with randomly made suffixes depending on the date and the prefix/code combination like:

| Prefix/Code | 28.09.2001 | 29.09.2001 | 30.09.2001 | 31.09.2001 |
|---|---|---|---|---|
| AA0001 | UK | GL | IC | E8 |
| AA0002 | ZE | 8J | E7 | OO |
| . . . | | | | |
| ZZ9999 | B7 | 9P | 6F | 24 |

Depending on the date and Prefix/Code combination the right suffix will be found. Between the solution of using an algorithm with numeric representation of date and prefix letters and the solution of lookup table combined solutions can be used. For example according to a prefix and date a factor will be looked up and used in an algorithm to decrease the steps of calculations.

| Prefix | 28.09.2001 | 29.09.2001 | 30.09.2001 | 31.09.2001 |
|---|---|---|---|---|
| AA | 6906 | 9698 | 8390 | 3377 |
| AB | 789679 | 769862 | 2787 | 278 |
| . . . | | | | |
| ZZ | 797 | 9798 | 9797 | 8787 |

Other algorithms should make use of: complex mathematics calculations like exp., In, log; taking digits from results (like the combination of third and fifth digit of a number with at least 6 digits): 123456→36; and using modulo operations. Such algorithms cannot be easily reversed engineered.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A method of providing mail piece franking by a party to a customer, comprising the steps of:
receiving a request from a customer for franking from said party, said request including mail piece information, said information comprising payment means;
generating an alphanumeric franking code based on an algorithm, said code related to said information;
transmitting said franking code to said customer;
affixing, by said customer, said franking code to said mail piece or mail piece;
receiving by said party said mail piece or mail piece with franking code affixed thereon;
verifying authenticity of said franking code; and
printing an tracking code on said mail piece or mail piece if said franking code is authentic.

2. The method according to claim 1, wherein said information further comprises date of purchase of said franking code.

3. The method according to claim 1, wherein said information further comprises date of purchase of said franking code. or delivery address;

4. The method according to claim 1, wherein said request is made over the Internet.

5. The method according to claim 1, wherein said request is made by a dial up computer connection.

6. The method according to claim 1, wherein said request is made by telephone.

7. The method according to claim 1, wherein said request is made by SMS.

8. The method according to claim 1, wherein said request is made by e-mail.

9. The method according to claim 1, wherein said franking code comprises a transaction number and said step of generating further comprises the step of linking and storing said transaction number and delivery address in a first database.

10. The method according to claim 9, wherein said step of verifying further comprises the steps of:
reading said affixed franking code and delivery address and
determining if a match to said read franking code and delivery address is present in said first database.

11. The method according to claim 10, wherein said step of reading is performed by a scanner comprising optical character recognition means.

12. The method according to claim 11, wherein said scanner is a videocoding device.

13. The method according to claim 1, wherein said step of affixing further comprises the step of marking said mail piece or mail piece with characters indicating presence of said franking code.

14. The method according to claim 1, wherein said tracking code is a bar code.

15. The method according to claim 1, wherein said franking code comprises a character symbol and four numerals.

16. The method according to claim 1, wherein said franking code comprises a precode, daily code and resulting code, said resulting code formed by application of said daily code and precode to said algorithm.

17. The method according to claim 1, wherein said algorithm is an encryption algorithm.

18. The method according to claim 1, wherein said step of verifying further comprises:
reading said resulting code;
generating a second resulting code by applying said algorithm to said precode and daily code; and
comparing said resulting code and second resulting code, such that matching first and second resulting codes indicates authenticity.

19. The method according to claim 18, wherein said step of reading is performed by a scanner comprising optical character recognition means.

20. The method according to claim 1, further comprising the step of deleting said franking code from a list of available franking codes, unless a flag is present indicating multiple use of said franking code.

21. The method according to claim 1, wherein said step of printing is performed manually.

22. The method according to claim 1, wherein said step of printing is performed by a printer.

23. The method according to claim 1, wherein said step of printing is performed by labeling means.

24. The method according to claim 10, further comprising the steps of:
relaying to a third party read affixed franking code;
third party authenticating of said franking code; and
communicating results of said step of authenticating to said party.

25. The method according to claim 19, further comprising the steps of:
delivering said mail piece by said party if said code is authentic; and
halting delivery of said mail piece by said party if said code is not authentic.

26. The method according to claim 1, wherein said party is a post office.

27. The method according to claim 26, wherein said party is a national post office.

28. The method according to claim 26, wherein said party is a corporation.

29. The method according to claim 1, wherein said step of verification further comprises the steps of:
generating a personal identification number (PIN);
providing the PIN to the customer by the party;
storing said PIN;
requesting said PIN from said customer after said mail piece has been posted;
comparing said requested PIN to said stored PIN, wherein a match indicates authenticity of said franking code.
